(19) United States
(12) Patent Application Publication
(10) Pub. No.: US 2026/0351659 A1
(43) Pub. Date: Nov. 5, 2026

(54) PANEL AND A BATTERY PACK FOR A LITHIUM SECONDARY BATTERY INCLUDING THE SAME

(71) Applicants: HYUNDAI MOTOR COMPANY, Seoul (KR); KIA CORPORATION, Seoul (KR); KWANG SUNG CORPORATION LTD, Dangjin-si (KR)

(72) Inventors: Duck Hyoung Hwang, Hwaseong-si (KR); Kyung Hwan Oh, Hwaseong-si (KR); Cheol Min Shin, Dangjin-si (KR); Hyun Woo Kim, Dangjin-si (KR); Sang Deok Kim, Dangjin-si (KR); Chung Woo Park, Dangjin-si (KR)

(73) Assignees: HYUNDAI MOTOR COMPANY, Seoul (KR); KIA CORPORATION, Seoul (KR); KWANG SUNG CORPORATION LTD, Dangjin-si (KR)

(21) Appl. No.: 19/361,798

(22) Filed: Oct. 17, 2025

(30) Foreign Application Priority Data
Apr. 30, 2025 (KR) 10-2025-0056844

(51) Int. Cl. H01M 10/052; C08K 5/00; H01M 10/658; H01M 50/227; H01M 50/231

(52) U.S. Cl. CPC H01M 10/052; C08K 5/0066; H01M 10/658; H01M 50/227; H01M 50/231

(57) ABSTRACT

A panel, and a battery pack for a lithium secondary battery including the same, includes a composite sheet including a substrate comprising a fibrous material, and a first thermoplastic resin impregnated in the substrate. The panel also includes a flame retardant sheet disposed on the composite sheet and including a second thermoplastic resin, a first flame retardant and a second flame retardant. The first flame retardant includes a halogen-based flame retardant, a phosphorus-based flame retardant, an inorganic flame retardant, or any combination thereof. The second flame retardant includes expandable graphite.

### CROSS-REFERENCE TO RELATED APPLICATION

This application claims, under 35 U.S.C. § 119 (a), the benefit of priority from Korean Patent Application No. 10-2025-0056844, filed on Apr. 30, 2025, the entire contents of which are incorporated herein by reference.

### BACKGROUND

### (a) Technical Field

The present disclosure relates to a panel and a battery pack for a lithium secondary battery including the same.

### (b) Background Art

As electric vehicles gain weight, energy efficiency decreases and fuel economy is lowered. Lithium secondary batteries, which may be considered a solution to energy depletion problems and carbon reduction, weigh approximately 250 kg, so weight reduction is an essential task.

The housing of a battery pack, which houses multiple battery modules, must be strong enough to protect the battery from various external factors during driving, and must not significantly affect the weight of the vehicle. Various methods are under study to solve this problem.

A protective panel located at the bottom of the housing of the battery pack is a part that protects the battery cooling channel and the battery. Currently, SMC (sheet molding compound), which is a composite of unsaturated polyester as a thermosetting resin and reinforced fiber, is being applied to the panel. SMC has a specific gravity of 1.8 to 2.1, which limits weight reduction, and cannot be recycled due to the use of the thermosetting resin, and thus does not comply with carbon reduction regulations.

### SUMMARY

Various aspects disclosed herein provide a panel that helps reduce weight due to low specific gravity and a battery pack for a lithium secondary battery including the same.

Another aspect disclosed herein provides a panel that is recyclable and a battery pack for a lithium secondary battery including the same.

Still another aspect disclosed herein provides a panel capable of protecting parts inside a battery pack from various external impacts and a battery pack for a lithium secondary battery including the same.

Various aspects are not limited to the foregoing. Various aspects should be able to be clearly understood through the following description and to be realized by the means described in the claims and combinations thereof.

Various aspects may provide a panel, including a composite sheet including a substrate including a fibrous material and a first thermoplastic resin impregnated in the substrate. The panel also includes a flame retardant sheet disposed on the composite sheet and including a second thermoplastic resin, a first flame retardant, and a second flame retardant.

The first flame retardant may include a halogen-based flame retardant, a phosphorus-based flame retardant, an inorganic flame retardant, or any combination thereof.

The second flame retardant may include expandable graphite.

The substrate may be a fabric in which the fibrous material is arranged in a warp direction and a weft direction.

The fibrous material may include synthetic fiber, natural fiber, inorganic fiber, or any combination thereof.

The fineness of the fibrous material may be 450 tex to 600 tex.

The first thermoplastic resin may include polyethylene, polypropylene, polyamide, acrylonitrile butadiene styrene, polycarbonate, polyethylene terephthalate, polyurethane, or any combination thereof.

The composite sheet may include the substrate and the first thermoplastic resin in a weight ratio of 1:1.2 to 1:1.4.

The composite sheet may include a plurality of substrates in a stacked configuration and the first thermoplastic resin impregnated in the plurality of substrates.

The thickness of the composite sheet may be 0.8 mm to 1.6 mm.

The second thermoplastic resin may include polyethylene, polypropylene, polyamide, acrylonitrile butadiene styrene, polycarbonate, polyethylene terephthalate, polyurethane, or any combination thereof.

The flame retardant sheet may include 30 wt % to 60 wt % of the second thermoplastic resin, 20 wt % to 50 wt % of the first flame retardant, and 10 wt % to 20 wt % of the second flame retardant.

The thickness of the flame retardant sheet may be 0.4 mm to 0.8 mm.

The panel may have a specific gravity of 0.9 to 1.5 as measured according to ISO 1183-1.

The panel may have impact absorption energy of 30 J or more as measured according to ISO 6603-2.

Based on the panel being treated with a flame at 1,100 °C to 1,300 °C, a perforation occurrence time may be after 5 minutes.

The panel may have tensile strength of 20 MPa to 90 MPa as measured according to ISO 527, and flexural strength of 30 MPa to 90 MPa and a flexural modulus of 800 MPa to 2,500 MPa as measured according to ISO 178.

Another embodiment of the present disclosure provides a battery pack, including a lithium secondary battery and a housing configured to accommodate the lithium secondary battery, in which at least one surface of the housing includes the panel described above.

### BRIEF DESCRIPTION OF THE DRAWINGS

Various aspects are described below in detail with reference to certain embodiments thereof illustrated in the accompanying drawings which are given hereinbelow by way of illustration only, and thus are not limitative of the present disclosure, and wherein:

FIG. 1 shows a housing of a battery pack according to an embodiment of the present disclosure;

FIG. 2 shows a panel according to an embodiment of the present disclosure;

FIG. 3 shows a composite sheet according to an embodiment of the present disclosure; and

FIG. 4 shows a composite sheet according to an embodiment of the present disclosure.

### DETAILED DESCRIPTION

The above and other aspects, features and advantages of the present disclosure should be more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals will refer to the same or like elements. For the sake of clarity of the present disclosure, the dimensions of structures are depicted as being larger than the actual sizes thereof. It should be understood that, although terms such as “first”, “second”, and the like may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

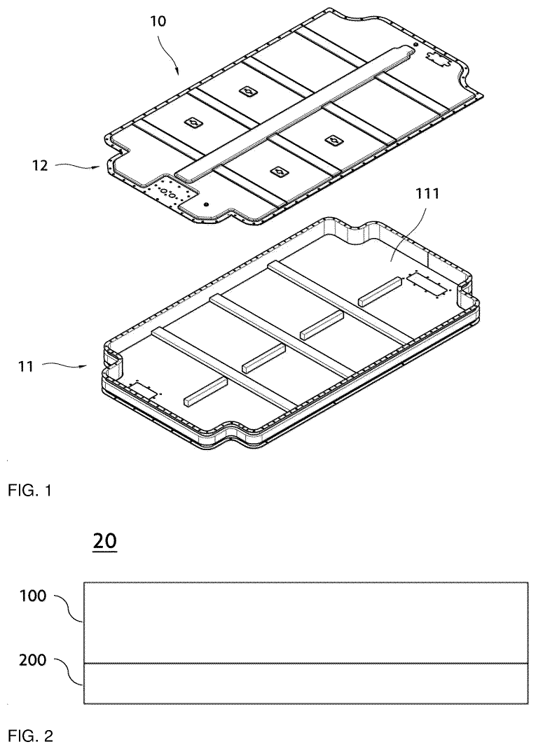

FIG. 1 shows a housing 10 of a battery pack. The housing 10 may include a case 11 configured to accommodate a battery pack inside and a cover 12 configured to cover the case 11. At least one surface of the housing 10 may include a panel. For instance, in one example, the lower surface 111 of the case 11 may include the panel.

FIG. 2 shows the panel 20. The panel 20 may include a composite sheet 100 and a flame retardant sheet 200 disposed on the composite sheet 100.

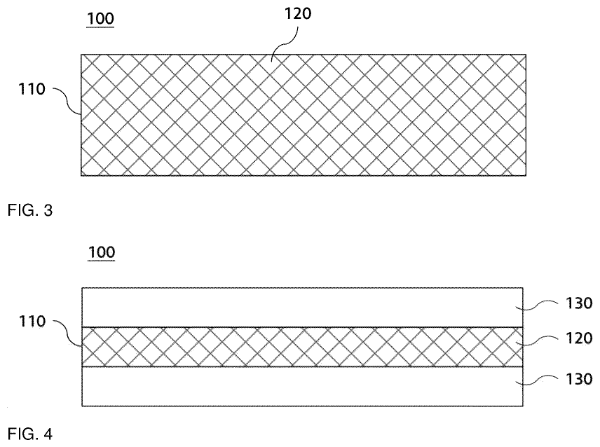

FIG. 3 shows the composite sheet 100 according to one embodiment. The composite sheet 100 may include a substrate 110 and a first thermoplastic resin 120 with which the substrate 110 is impregnated.

FIG. 4 shows a composite sheet 100 according to another embodiment. The composite sheet 100 may include a substrate 110, a first thermoplastic resin 120 with which the substrate 110 is impregnated, and a resin layer 130 formed on at least one surface of the substrate 110 and including the first thermoplastic resin 120.

The composite sheet of FIG. 3 may be configured such that the thickness of the substrate 110 is the same as the thickness of the composite sheet 100 and the substrate 110 is impregnated with the first thermoplastic resin 120. The composite sheet of FIG. 4 may be configured such that the thickness of the substrate 110 is less than the thickness of the composite sheet 100, the substrate 110 is impregnated with the first thermoplastic resin 120, and the first thermoplastic resin 120 remaining after impregnation is formed into the resin layer 130 on at least one surface of the substrate 110. The composite sheet 100 may be configured such that a plurality of substrates 110 is stacked and impregnated with a first thermoplastic resin 120.

The substrate 110 may include a fibrous material. The substrate 110 may include a fabric in which fibrous materials are arranged in warp and weft directions. For example, the substrate 110 may be a fabric in which fibrous materials are arranged at a density of about 10/inch to 20/inch in the warp direction and at a density of about 20/inch to 30/inch in the weft direction. The fabric may be knitted or twilled. However, the form of the substrate 110 is not particularly limited, and any form may be applied so long as fibrous materials are irregularly or regularly entangled with each other to afford a net structure.

The fibrous material may include synthetic fiber, natural fiber, inorganic fiber, or any combination thereof. The synthetic fiber may include polyvinyl alcohol, polyethylene terephthalate, polyethylene, polypropylene, acrylic, polyacrylonitrile, rayon, carbon fiber, or any combination thereof. The natural fiber may include cellulose, flax, wood fiber, or any combination thereof. The inorganic fiber may include glass fiber, rock wool, basalt fiber, or any combination thereof. In one example, the fibrous material includes glass fiber. For example, the glass fiber may be long fiber having a length of about 1 mm to 50 mm.

The fineness of the fibrous material may be about 450 tex to 600 tex. If the fineness of the fibrous material is less than 450 tex, durability may deteriorate and heat resistance may decrease. On the other hand, if the fineness of the fibrous material exceeds 600 tex, the panel 20 may become heavy and effective dissipation of heat may become difficult.

The first thermoplastic resin 120 may include polyethylene, polypropylene, polyamide, acrylonitrile butadiene styrene, polycarbonate, polyethylene terephthalate, polyurethane, or any combination thereof. In one example, the first thermoplastic resin 120 includes polyethylene or polypropylene. The panel 20 according to the present disclosure may include the first thermoplastic resin 120 that is recyclable, unlike conventional panels using thermosetting resins.

The composite sheet 100 may include the substrate 110 and the first thermoplastic resin 120 in a weight ratio of about 1:1.2 to 1:1.4. If the weight ratio is less than 1:1.2, the amount of the first thermoplastic resin 120 is low, so the bonding strength and dimensional stability of the composite sheet 100 may decrease, and thermal and chemical stability may deteriorate. On the other hand, if the weight ratio exceeds 1:1.4, the panel 20 may become heavy and flexibility may decrease, resulting in poor processability.

The thickness of the composite sheet 100 may be about 0.8 mm to 1.6 mm. If the thickness of the composite sheet 100 is less than 0.8 mm, the lithium secondary battery inside the battery pack may not be protected from external impact, whereas if the thickness of the composite sheet 100 exceeds 1.6 mm, it may be disadvantageous in weight reduction.

The flame retardant sheet 200 may include a second thermoplastic resin, a first flame retardant, and a second flame retardant. The flame retardant sheet 200 may further include a filler as necessary.

The second thermoplastic resin may include polyethylene, polypropylene, polyamide, acrylonitrile butadiene styrene, polycarbonate, polyethylene terephthalate, polyurethane, or any combination thereof. The second thermoplastic resin may be the same as or different from the first thermoplastic resin 120.

The first flame retardant may include a halogen-based flame retardant, a phosphorus-based flame retardant, an inorganic flame retardant, or any combination thereof.

The halogen-based flame retardant may include a brominated flame retardant, a chlorinated flame retardant, or a combination thereof. The brominated flame retardant may include tribromophenoxyethane, tetrabromobisphenol A, or a combination thereof. The chlorinated flame retardant may include chlorinated paraffin, chlorinated polyethylene, an aliphatic chlorinated flame retardant, or any combination thereof.

The phosphorus-based flame retardant may include at least one functional group of phosphate, phosphonate, phosphinate, phosphine oxide, or phosphazene, and may include a phosphorus/halogen flame retardant, a phosphorus/nitrogen flame retardant, and the like.

The inorganic flame retardant may include aluminum hydroxide (Al(OH)₃), antimony oxide (Sb₂O₃), magnesium hydroxide (Mg(OH)₂), or any combination thereof.

The second flame retardant may include expandable graphite. The expandable graphite is a flame retardant that forms a solid layer, and the expanded carbon layer acts as an insulating layer to prevent heat transfer. The expandable graphite may be employed as a low-flame, eco-friendly flame retardant of a non-halogen type. When expandable graphite expands due to heat, it has excellent heat insulating properties in the direction perpendicular to the plane of the layer. The expandable graphite has the advantages of being non-toxic, lightweight, containing no halogen components, being insoluble in water, and not generating toxic gases.

The filler may include calcium carbonate, silicate, clay, glass fiber, carbon fiber, or any combination thereof. The filler includes glass fiber.

The flame retardant sheet 200 may include about 30 wt % to 60 wt % of the second thermoplastic resin, about 20 wt % to 50 wt % of the first flame retardant, and about 10 wt % to 20 wt % of the second flame retardant. The flame retardant sheet 200 may include about 30 wt % to 60 wt % of the second thermoplastic resin, about 20 wt % to 50 wt % of the first flame retardant, about 10 wt % to 20 wt % of the second flame retardant, and about 5 wt % to 15 wt % of the filler. When the amount of each component of the flame retardant sheet 200 falls within the above numerical ranges, flame retardancy and physical properties of the panel 20 may be improved.

The thickness of the flame retardant sheet 200 may be about 0.4 mm to 0.8 mm. If the thickness of the flame retardant sheet 200 is less than 0.4 mm, flame retardancy may deteriorate, whereas if the thickness of the flame retardant sheet 200 exceeds 0.8 mm, it may be disadvantageous in weight reduction.

The panel 20 satisfying the above conditions may have a specific gravity of about 0.9 to 1.5 as measured according to ISO 1183-1. The panel 20 may help reduce the weight of the battery pack.

Also, the panel 20 may have impact absorption energy of about 30 J or more as measured according to ISO 6603-2. The upper limit of the impact absorption energy is not particularly limited, and may be 200 J or less, 150 J or less, or 100 J or less. The panel 20 may have tensile strength of about 20 MPa to 90 MPa as measured according to ISO 527, and flexural strength of about 30 MPa to 90 MPa and a flexural modulus of about 800 MPa to 2,500 MPa as measured according to ISO 178. A housing to which the panel 20 is applied is able to protect a lithium secondary battery inside.

Based on the panel 20 being treated with a flame at 1,100 °C to 1,300 °C, a perforation occurrence time may be after about 5 minutes. The upper limit of the perforation occurrence time is not particularly limited, and may be 1 hour or less, 50 minutes or less, 40 minutes or less, or 30 minutes or less. The housing to which the panel 20 is applied is heat-resistant and is able to protect the lithium secondary battery inside.

A better understanding of the present disclosure may be obtained through the following examples, but these examples are not to be construed as limiting the present disclosure.

### Example 1

A substrate woven from glass fiber having a fineness of about 600 tex was prepared. A composite sheet was manufactured by impregnating the substrate with polyethylene followed by drying at room temperature. Specifically, sheets composed of polyethylene were laminated on both surfaces of the substrate followed by pressing at a pressure of about 7.0 kPa to 9.0 kPa at about 200 °C to 240 °C to impregnate the substrate with polyethylene. The weight ratio of the substrate to the polyethylene in the composite sheet is as shown in Table 1 below. The thickness of the composite sheet is about 1.2 mm.

A flame retardant sheet was manufactured by mixing a second thermoplastic resin, a first flame retardant, a second flame retardant, and a filler in the amounts shown in Table 1 followed by extrusion into a sheet. The second thermoplastic resin is polypropylene and the filler is glass fiber. The thickness of the flame retardant sheet is about 0.6 mm.

A panel was manufactured by placing the flame retardant sheet on the composite sheet followed by pressing.

### Example 2

A panel was manufactured in the same manner as in Example 1, with the exception that the weight ratio of the substrate to the polyethylene in the composite sheet was changed, as shown in Table 1.

### Example 3

A panel was manufactured in the same manner as in Example 1, with the exception that a substrate woven from glass fiber having a fineness of about 450 tex was used.

### Comparative Examples 1 and 2

Respective panels were manufactured in the same manner as in Example 1, with the exception that a substrate woven from glass fiber having a fineness of about 300 tex was used and the composition of the flame retardant sheet was changed.

TABLE 1

| | Example | Example | Example | Comparative | Comparative |
|---|---|---|---|---|---|
| Items | 1 | 2 | 3 | Example 1 | Example 2 |
| Weight ratio of | 1:1.2 | 1:1.4 | 1:1.2 | 1:1.2 | 1:1.2 |
| substrate to | | | | | |
| polyethylene in | | | | | |
| composite sheet | | | | | |
| Fineness of glass fiber | 600 | 600 | 450 | 300 | 300 |
| of substrate [tex] | | | | | |
| Amount of second | 52.6 | 52.6 | 52.6 | 74.3 | 68.8 |
| thermoplastic resin | wt % | wt % | wt % | wt % | wt % |
| Amount of first flame | 21.1 | 21.1 | 21.1 | 14.3 | 0 |
| retardant | wt % | wt % | wt % | wt % | wt % |
| Amount of second | 15.8 | 15.8 | 15.8 | 0 | 25 |
| flame retardant | wt % | wt % | wt % | wt % | wt % |
| Amount of filler | 10.5 | 10.5 | 10.5 | 11.4 | 6.2 |
| | wt % | wt % | wt % | wt % | wt % |

The specific gravity, impact absorption energy, and flame-induced perforation occurrence time of the panels according to Examples 1-3 and Comparative Examples 1 and 2 were measured as follows. The results are shown in Table 2 below.

### 5 [Specific Gravity]

1) Test standard: ISO 1183-1
2) Test method: Measure specific gravity using the immersion method among the immersion method, liquid pycnometer method, and titration method (principle of electronic hydrometer)
   Measurement of apparent mass (m_{S,A}) of the test piece in air
   Measurement of apparent mass (m_{S,IL}) of the test piece in liquid (water)
   Density of the test piece (ρ_{S})=(m_{S,A}×β_{IL})/(m_{S,A}−m_{S,IL}), where ρ_{IL} is the density of liquid (water).
   Specific gravity of the test piece(S)=ρ_{S}/β_{IL}
   After measurement three times, determine the average value

### [Impact Absorption Energy]

1) Test standard: ISO 6603-2
2) Test method: Using a lubricated striking rod, strike the center of the surface of the test piece vertically at a constant speed until perforation occurs, and record the force-deflection graph
3) Test conditions: Test mass of 20 kg, test speed of 4.4 m/s, drop weight type: 20 mm semicircle weight

### [Flame-Induced Perforation Occurrence Time]

1) Test method
   Flame source: butane gas torch
   Measurement of the temperature by attaching a temperature measuring device to the front and back of the heating point of the test piece during evaluation
   Flame temperature: >1,000 °C
   Flame distance: 7 cm
2) Judgment: Measure the perforation occurrence time on the back of the test piece

TABLE 2

| | Example | Example | Example | Comparative | Comparative |
|---|---|---|---|---|---|
| Items | 1 | 2 | 3 | Example 1 | Example 2 |
| Specific gravity | 1.42 | 1.47 | 1.42 | 1.42 | 1.42 |
| Impact | 39 | 42 | 32 | 28 | 27 |
| absorption | | | | | |
| energy [J] | | | | | |
| Perforation | 6 min 30 | 7 min 10 | 5 min 25 | 25 sec | 19 sec |
| occurrence time | sec | sec | sec | | |

Referring to Table 2, Examples 1-3 had low specific gravity, making it possible 10 to reduce the weight of the battery pack. In addition, the impact absorption energy and the flame-induced perforation occurrence time were superior to those of Comparative Examples 1 and 2, making it possible to effectively protect the lithium secondary battery inside the battery pack.

As is apparent from the foregoing, the panel that helps reduce weight due to low specific gravity and the battery pack for the lithium secondary battery including the same can be obtained.

The panel that is recyclable and the battery pack for the lithium secondary battery including the same can be obtained.

The panel capable of protecting parts inside the battery pack from various external impacts and the battery pack for the lithium secondary battery including the same can be obtained.

The effects of the present disclosure are not limited to the foregoing. It should be understood that the effects of the present disclosure include all effects that can be inferred from the description of the present disclosure.

As described hereinbefore, although the embodiments have been described, those having ordinary skill in the art will appreciate that various modifications and alterations are possible from the foregoing. For example, even when the described techniques are performed in an order different from the described method and/or even when the described components such as systems, structures, devices, circuits, etc. are linked or combined in a different form from the described method or are replaced or substituted by other components or equivalents, it is possible to achieve appropriate results. Therefore, other embodiments, other examples, and equivalents to the claims are also within the scope of the following claims.

What is claimed is:

1. A panel, comprising:
a composite sheet comprising a substrate comprising a fibrous material, and a first thermoplastic resin impregnated in the substrate; and
a flame retardant sheet disposed on the composite sheet and comprising a second thermoplastic resin, a first flame retardant and a second flame retardant,
wherein the first flame retardant comprises a halogen-based flame retardant, a phosphorus-based flame retardant, an inorganic flame retardant, or any combination thereof, and
wherein the second flame retardant comprises expandable graphite.

2. The panel of claim 1, wherein the substrate is a fabric in which the fibrous material is arranged in a warp direction and a weft direction.

3. The panel of claim 1, wherein the fibrous material comprises synthetic fiber, natural fiber, inorganic fiber, or any combination thereof.

4. The panel of claim 1, wherein a fineness of the fibrous material is 450 tex to 600 tex.

5. The panel of claim 1, wherein the first thermoplastic resin comprises polyethylene, polypropylene, polyamide, acrylonitrile butadiene styrene, polycarbonate, polyethylene terephthalate, polyurethane, or any combination thereof.

6. The panel of claim 1, wherein the composite sheet comprises the substrate and the first thermoplastic resin in a weight ratio of 1:1.2 to 1:1.4.

7. The panel of claim 1, wherein the composite sheet comprises a plurality of substrates in a stacked configuration and the first thermoplastic resin impregnated in the plurality of substrates.

8. The panel of claim 1, wherein a thickness of the composite sheet is 0.8 mm to 1.6 mm.

9. The panel of claim 1, wherein the second thermoplastic resin comprises polyethylene, polypropylene, polyamide, acrylonitrile butadiene styrene, polycarbonate, polyethylene terephthalate, polyurethane, or any combination thereof.

10. The panel of claim 1, wherein the flame retardant sheet comprises 30 wt % to 60 wt % of the second thermoplastic resin, 20 wt % to 50 wt % of the first flame retardant, and 10 wt % to 20 wt % of the second flame retardant.

11. The panel of claim 1, wherein a thickness of the flame retardant sheet is 0.4 mm to 0.8 mm.

12. The panel of claim 1, wherein the panel has a specific gravity of 0.9 to 1.5 as measured according to ISO 1183-1.

13. The panel of claim 1, wherein the panel has impact absorption energy of 30 J or more as measured according to ISO 6603-2.

14. The panel of claim 1, wherein, based on the panel being treated with a flame at 1,100 °C to 1,300 °C, a perforation occurrence time is after 5 minutes.

15. The panel of claim 1, wherein the panel has tensile strength of 20 MPa to 90 MPa as measured according to ISO 527, and flexural strength of 30 MPa to 90 MPa and a flexural modulus of 800 MPa to 2,500 MPa as measured according to ISO 178.

16. A battery pack, comprising:
a lithium secondary battery; and
a housing configured to accommodate the lithium secondary battery,
wherein at least one surface of the housing comprises a panel, the panel comprising:
a composite sheet comprising a substrate comprising a fibrous material, and a first thermoplastic resin impregnated in the substrate; and
a flame retardant sheet disposed on the composite sheet and comprising a second thermoplastic resin, a first flame retardant and a second flame retardant,
wherein the first flame retardant comprises a halogen-based flame retardant, a phosphorus-based flame retardant, an inorganic flame retardant, or any combination thereof, and
wherein the second flame retardant comprises expandable graphite.

17. The battery pack of claim 16, wherein the substrate is a fabric in which the fibrous material is arranged in a warp direction and a weft direction.

18. The battery pack of claim 16, wherein the fibrous material comprises synthetic fiber, natural fiber, inorganic fiber, or any combination thereof.

19. The battery pack of claim 16, wherein the composite sheet comprises a plurality of substrates in a stacked configuration and the first thermoplastic resin impregnated in the plurality of substrates.

20. The battery pack of claim 16, wherein the first thermoplastic resin and the second thermoplastic resin comprises polyethylene, polypropylene, polyamide, acrylonitrile butadiene styrene, polycarbonate, polyethylene terephthalate, polyurethane, or any combination thereof.
